(19) United States
(12) Patent Application Publication
(10) Pub. No.: US 2004/0156430 A1
(43) Pub. Date: Aug. 12, 2004

(54) Component measures

(76) Inventor: Natividade Albert Lobo, Berkshire (GB)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/432,669

(22) PCT Filed: Nov. 23, 2001
(86) PCT No.: PCT/EP01/14282

(30) Foreign Application Priority Data
Nov. 24, 2000 (GB) 0028728.4
Jun. 29, 2001 (GB) 0116003.5

(51) Int. Cl. H04Q 1/20

(52) U.S. Cl. 375/224

(57) ABSTRACT

A method of testing a signal processing component suitable for a device operating in a spread spectrum system by correlating a comparison output signal with a modified output signal wherein the modification is attributable to the signal processing operation performed by the device under test.

The invention relates to measuring signal impairment as a result of individual components in spread spectrum systems.

In the past there has been a limited ability to determine the impact of a particular component on signal degradation for analog systems. Analog systems for the purpose of this application mean systems where all the information transmitted is held on a single analog pulse.

Filters in a communications device have a particular impact on the degradation of the output signal. In order to assess the impact a particular filter will have on signal degradation the manufacturer generally provides information on a filter of by way of a data sheet. The data sheet will typically specify the signal to noise ratio of the filter, the in-band ripple, the linearity of phase and the group delay time. The first two figures help a designer in deciding whether a particular filter is suitable for the application required and the linearity of phase and the group delay time allow characteristics of the filter to be factored in to the design of the device.

In spread spectrum systems, all the information transmitted is not retrievable from a single received pulse. For example in WCDMA each data element is modulated using a code comprising a string of positive and negative bits specific to an individual system user to create a set of data pulses. The entire set is transmitted. This allows the value of the data element to be retrieved if only a subset of the pulses transmitted is accurately received. The value of the bit is, however, calculated using all the received pulses both accurate and inaccurate rather than from an individual pulse as in analog systems.

The assessment data currently supplied for filters and other system components is useful in designing for analog systems where calculations are performed on individual pulses to determine the value of a transmitted data element. For spread spectrum systems, there is no equivalent test for components. To gain an idea of the degradation of the signal the whole system would be simulated and the final bit error rate measured.

In accordance with one aspect of the present invention there is provided a method of testing a signal processing component suitable for a device operating in a spread spectrum system in accordance with a predetermined modulation scheme, the method comprising: providing an input signal; generating a comparison output signal modulated in accordance with the predetermined modulation scheme from the input signal; generating a modified output signal modulated in accordance with the predetermined modulation scheme and modified such that the difference between the modified output signal and the comparison output signal is attributable to the signal processing operation performed by the device under test; correlating the modulated modified output signal operated on by the device under test with the modulated comparison output signal to provide a measure of the degradation on the signal of the component under test.

Embodiments of the invention are available that generate the modified signal and comparison signal at the same time. This allows the correlation to be run in real time. In alternative embodiments the comparison signal and the modified signal may be generated separately at different times, signals being stored and correlated subsequently.

The comparison signal is preferably the input signal modulated under the control of the ideal clock although other signals of known distortion could be used. For components that operate on a modulated signal such as filters and amplifiers, conveniently the modified signal is the modulated comparison signal subsequently operated on by the component under test. When the component under test is a filter the effectiveness of the filter is factored into the measure. This can be achieved by comparing the resulting correlation with the power throughput this provides additional information in the measure. Similar arrangements could be used to determine the effectiveness of other components that operate on the modulated signal.

When the component under test is used in generating the modulated signal, for example where the component is a timing element such as a clock, the modified signal is generated from an independent modulation of the input signal and the comparison made with an idealised version of the same component used during modulation. For example, if the component is a clock in embodiments of the invention the modified comparison signals are respectively generated by modulating the same input signal using a real and an ideal clock. To provide a measure at the end that is dimensionless, the correlation between the modified and comparison signals is compared with the self correlation of the comparison signal.

If the result of the correlation is an imaginary number the measure of the degradiation may be formed from the complex conjugate of the correlation.

According to another aspect of the invention there is provided means for testing a signal processing component suitable for a device operating in a spread spectrum system in accordance with a predetermined modulation scheme, the method comprising: means for providing an input signal; means for generating a comparison output signal modulated in accordance with the predetermined modulation scheme from the input signal; means for modifying the means for generating the comparison output signal such that the difference between the modified output signal and the comparison output signal is attributable to the signal processing operation performed by the component under test; means for generating the modified output signal in accordance with the predetermined modulation scheme; means for correlating the modified output signal operated on by the device under test with the modulated comparison output signal to provide a measure of the degradation on the signal of the component under test.

In accordance with a further aspect of the invention there is provided a characteristic of a component for use in a device for operation in a spread spectrum system, the characteristic comprising: a measure of the signal distortion attributable to the component for a specified spread spectrum modulation scheme.

In accordance with yet another aspect of the invention there is provided a method for testing a signal processing component suitable for a device operating in a spread spectrum system in accordance with a predetermined modulation scheme, the method comprising: providing an input signal; generating an output signal modulated in accordance with the predetermined modulation scheme of known distortion from the input signal; generating an output signal modulated in accordance with the predetermined modulation scheme and operated on by the device under test from the input signal; correlating the modulated output signal operated on by the device under test with the modulated output signal of known distortion to provide a measure of the degradation on the signal of the component under test.

The step of generating an output signal of known distortion may comprise modulating the input signal under the control of a clock of known distortion, for example an ideal clock although other clocks could be used provided the distortion they introduce to the system is separately known.

In accordance with a yet further aspect of the invention there is provided a data sheet for association with a component or set of similar components providing a correlation peak measure for a specified spread spectrum modulation scheme indicating the signal distortion attributable to the component operating on a signal modulated in accordance with the specified scheme.

The provision of a data sheet with individual components that include the measure including the correlation data, provides the designer with data not previously available allowing the intellegent selection of components for use in devices operating a particular modulation scheme. The data sheet may have a range of measures indicating the suitability of the component to a number of different modulation schemes.

The invention provides a versatile method and apparatus for testing and specifying system components so that the contribution of individual elements to signal degradation can be assessed. It leads to the creation of new units of measurement for individual components.

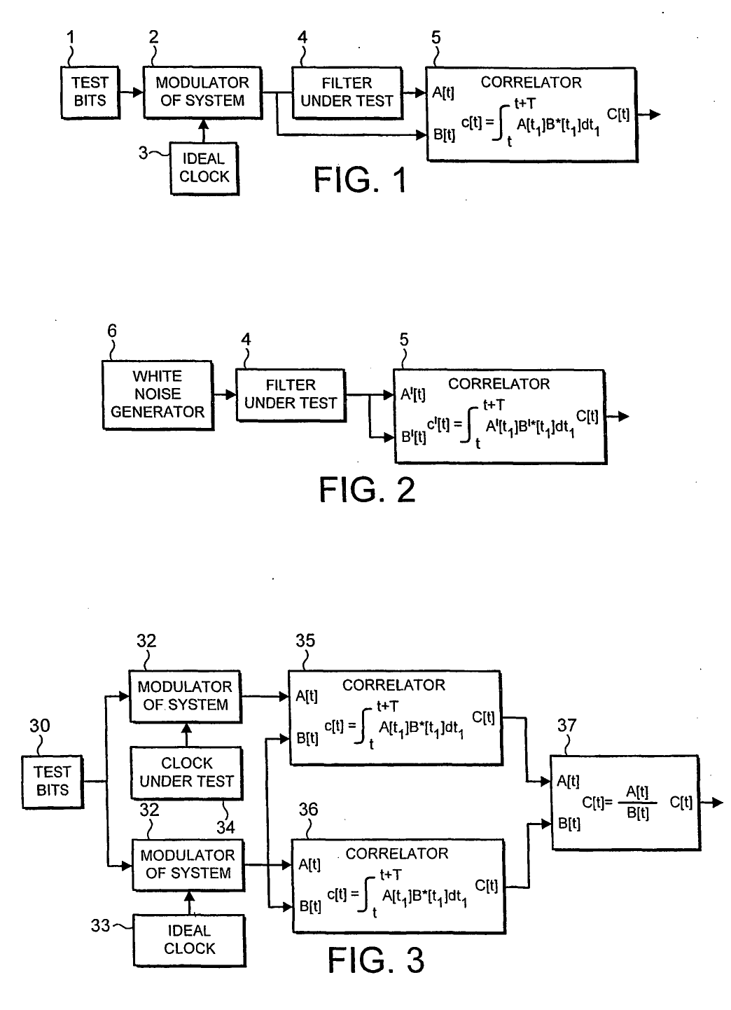

The invention will now be described in greater detail with reference to FIGS. 1 to 5 of the accompanying drawings of which:

FIG. 1 is a schematic representation of a first embodiment of the invention for testing a filter;

FIG. 2 is a schematic representation of a second embodiment of the invention for testing a filter; and

FIG. 3 is a schematic representation of a third embodiment of the invention for testing a clock.

In spread spectrum systems such as WCDMA, GPS, TDD, unlike analog systems such as GSM, a single received pulse is not sufficient to decode the information in a message. Typically in spread spectrum systems each system user has a unique code comprising a string of 1 s and (−1 s) for example {1, −1, 1, −1, −1, 1}. Each bit of the bit stream to be transmitted would then be spread using the unique code allocated to the user to create a number of pulses. When a pulse stream is received a correlation operation is performed in order to decode the received message. The higher the number of spread bits that are received correctly, the higher the correlation. The correlation is generally achieved by multiplying the received spread bits by the known unique code. If the bit has been correctly received the result will be a positive number. If not it will be negative. In spread spectrum systems, the number of errors received or the bit error rate provides an indication of the strength of the signal.

As stated in the introduction, in the past this has been the only measure that could be made. It was a matter for intuition or guesswork as to which of the components or elements of the system were causing the greatest degradation to the signal. Using the present invention each element of the system can be tested in isolation to determine its effect on the correlation between the transmitted and received signals. This will allow components to be selected that improve the bit error rate of the system.

In the first illustrated example, the element under test is a filter 10. FIG. 1 shows a generator for generating test bits 1, a modulator 2 generating the pulses for transmission B(t) under the control of an ideal clock 3. The input signal is suitably a synchronisation frame. The modulation scheme selected for this element of the equipment can be changed so the characteristics of the filter in operation for a number of modulation schemes can be measured. The pulse stream generated is then passed through the filter under test 4. The output from the filter A(t) is then correlated with the unfiltered pulse stream B(t). c(t)=∫ₜ^{t+T}A[t₁]B*[t₁]dt₁ This operation could be completed in real time with two inputs A(t) and B(t) as illustrated in FIG. 1. It could, however, be achieved by storing the filtered output and the unfiltered output on separate occasions and then performing a correlation.

A correlation operation 5 is used to assess the difference between the filtered and unfiltered data streams as this is similar to the operation used to decode the received data streams in operation. If the correlation between the two streams is poor, the bit error rate when a pulse stream using the tested filter is transmitted would be high. The correlation between filtered and unfiltered systems will be different for different modulation schemes. Not only because the frequency may alter but also because other factors may also effect the performance of the filter for a particular scheme. The correlation between the unfiltered and filtered signal will be termed for the purposes of this application the correlation peak.

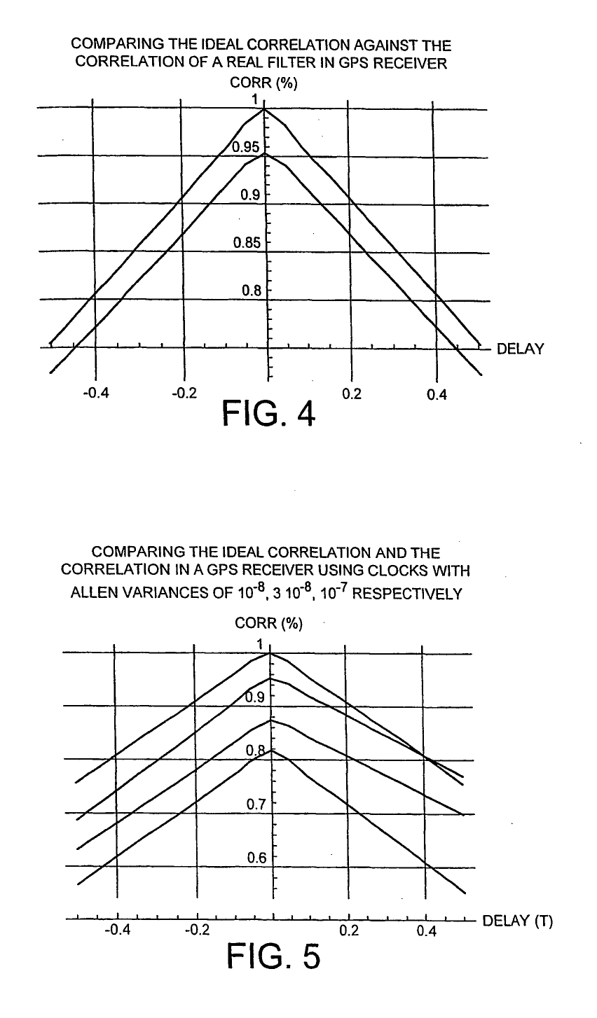

This test on its own provides some information on the filter. However, a component that performed no filtering function may provide a very good correlation between the input signal and the output signal. A second test may then be conducted on a filter to show how effective a filter it is. FIG. 2 shows a white noise generator being fed through a filter under test. By correlating the filtered output with itself, the power passing through the filter is measured. The higher the power the less effective the filter will be as it will be letting through a large window of frequencies. By dividing the correlation peak achieved from the apparatus of FIG. 1 by the power measure of the apparatus of FIG. 2, a measure of the effectiveness of the filter is achieved. If white noise with a unit power spectral density is used a normalized figure can be reproduced. The result of the test of FIG. 1 could be high but if the result from FIG. 2 is also high the final measure would be low. Similarly, the correlation from FIG. 1 may be low but the power from the test of FIG. 2 could also be low providing the same result. A graph depicting a comparison of a real filter in a GPS receiver is illustrated in FIG. 4 by way of example only.

The suitability of a device for a particular modulation scheme can be determined by using that modulation scheme in the test apparatus of FIG. 1. The data for each relevant modulation scheme can then be recorded and provided in association with the filter to enable designers to select a filter suitable for a particular system and modulation scheme.

A filter or set of filters may be supplied with a correlation peak to noise ratio for a single or range of modulation schemes tested. Designers can then select a filter suitable for one of a range of spread spectrum modulations schemes including WCDMA GPS and TDD. The correlation to noise peak ratio may be provided as a data sheet attached to number of filters delivered in bulk or to a single filter it could also be provided on a label attached to individual filters or on individual or bulk packages. In addition the values of the ratio may be held on a data base accessible to the designer associated with the name or label of the filter.

The fundamental method used to test filters and assign to them a value that indicates their performance for a particular modulation scheme can also be used to assess other signal processing components of the system. Another group of components operate under the control of a clock. These components affect the timing of the transmitted pulses and can therefore affect the correlation achieved when the transmitted signal is received.

FIG. 3 shows a system that can be used to test a clock component. Test bits are generated 30 and fed to a modulator 32 operating under the control of an ideal clock 33. An output signal A(t) is generated. At the same or a separate time, the same generated test bits are fed to a modulator 32 operating under the control of a clock under test. An output signal B(t) is generated. A correlation operation c(t)=∫ₜ^{t+T}A[t₁]B*[t₁]dt₁ is then performed on the modulated signal generated under control of an ideal clock and the modulation signal generated under control of the clock under test 35. This provides an indication of the degradation of the signal as a result of the clock under test. To provide a dimensionless quantity, a separate correlation operation is performed between the signal modulated by the ideal clock with itself 36. The output of the correlation with the clock under test is then divided with the self correlation output 37 to provide a value that indicates the amount of degradation on a signal for the particular modulation scheme tested attributable to the clock under test. A graph depicting a comparison of real clocks with Allen Variances of 10⁻⁸, 3.10⁻⁸ and 10⁻⁷ can be seen in FIG. 5 for illustrative purposes only.

The test apparatus described in relation to a clock can be adapted for use with components such as clocks, and to test automatic frequency control algorithms and synchronization algorithms. These components could be rated for use with a particular modulation scheme as could components incorporating the algorithms. Again the data indicating the degradation of the signal attibutable to individual components could be provided as a data sheet or other form of labelling attached to individual or multiple components. For each component the correlation between the comparison and modified signals is again termed the correlation peak.

More detail of the mathematics and example correlations for a GPS signal can be found in the annex attached to priority application UK 0028728.4 incorporated herein by reference copy attached to the application as filed.

The present invention includes any novel feature or combination of features disclosed herein either explicitly or any generalisation thereof irrespective of whether or not it relates to the claimed invention or mitigates any or all of the problems addressed.

In view of the foregoing description it will be evident to a person skilled in the art that various modifications may be made within the scope of the invention.

In particular the skilled man will realise that embodiments in accordance with the present invention can be used to test a range of elements of the system including but not restricted to filters, amplifiers including low noise amplifiers, mixers and timing elements such as clocks, automatic frequency control algorithms and synchronization algorithms. For each component a correlation peak data for a particular modulation scheme will provide useful design information.

1. A method of testing a signal processing component suitable for a device operating in a spread spectrum system in accordance with a predetermined modulation scheme, the method comprising:
providing an input signal;
generating a comparison output signal modulated in accordance with the predetermined modulation scheme from the input signal;
generating a modified output signal modulated in accordance with the predetermined modulation scheme and modified such that the difference between the modified output signal and the comparison output signal is attributable to the signal processing operation performed by the device under test;
correlating the modulated modified output signal operated on by the device under test with the modulated comparison output signal to provide a measure of the degradation on the signal of the component under test.

2. A method of testing a signal processing component according to claim 1, wherein the comparison output signal is generated using an ideal clock.

3. A method of testing a signal processing component according to claim 1 or claim 2, wherein the modified output signal is the output signal modulated under the control of the ideal clock.

4. A method of testing a signal processing component according to any preceding claim, wherein the modified signal is the modulated comparison signal subsequently operated on by the component under test.

5. A method of testing a signal processing component according to any one of claims 1 to 3, wherein the modified signal is generated from an independent modulation of the input signal.

6. A method of testing a signal processing component according to any preceding claim, wherein the measure comprises the result of the correlation compared with the self correlation of the comparison signal.

7. A method of testing a signal processing component according to any preceding claim wherein the input signal is a data string.

8. A method of testing a signal processing component according to any preceding claim wherein the input signal is a synchronisation frame.

9. A method of testing a signal processing component according to any preceding claim wherein the component is a filter.

10. A method of testing a signal processing component according to any one of claims 1 to 8 wherein the component is an amplifier.

11. A method of testing a signal processing component according to any one of claims 1 to 8 wherein the amplifier is a low noise amplifier.

12. A method of testing a signal processing component according to any one of claims 1 to 8 wherein the component is a mixer.

13. A method of testing a signal processing component according to any one of claims 1 to 8 wherein the component comprises a timing element.

14. A method of testing a signal processing component according to claim 13 wherein the timing element comprises a clock.

15. A method of testing a signal processing component according to claim 13 wherein the timing element comprises an automatic frequency control algorithm.

16. A method of testing a signal processing component according to claim 13 wherein the timing element comprises a synchronization algorithm.

17. A method of testing a signal processing component according to any preceding claim wherein the method further comprises the step of measuring the affect of the component under test on the power transmitted.

18 A method of testing a signal processing component according to claim 17 wherein the measure is the ratio between the output of the correlation and the power transmitted.

19. A method of testing a signal processing component according to claim 17 or 18 wherein the power transmitted is calculated by correlating the output of the component under test operating on white noise with itself.

20. A method of testing a signal processing component according to claim 19 wherein a normalized figure is produced by using white noise with a unit power spectral density.

21. A method of testing a signal processing component according to any preceding claim wherein if the result of the correlation is an imaginary number the measure is formed from the complex conjugate of the correlation.

22. Apparatus for testing a signal processing component suitable for a device operating in a spread spectrum system in accordance with a predetermined modulation scheme, comprising:
means for providing an input signal;
means for generating a comparison output signal modulated in accordance with the predetermined modulation scheme from the input signal;
means for generating a modified output signal modulated in accordance with the predetermined modulation scheme such that the difference between the modified output signal and the comparison output signal is attributable to the signal processing operation performed by the component under test;
means for correlating the modified output signal operated on by the device under test with the modulated comparison output signal to provide a measure of the degradation on the signal of the component under test wherein the modified and comparison signals are generated at the same time.

23. Means for testing a signal processing component according to claim 22, wherein the modulation signal and comparison signal are generated at the same time.

24. Apparatus for testing a signal processing component according to claim 22, wherein the modulation signal and comparison signal are generated at different times.

25. A characteristic of a component for use in a device for operation in a spread spectrum system, the characteristic comprising:
a measure of the signal distortion attributable to the component for a specified spread spectrum modulation scheme.

26. A characteristic of a component according to claim 25, wherein the measure is a correlation peak.

27. A characteristic of a component according to claims 25 or 26 wherein a factor in the measure comprises the correlation between respective signals.

28. A characteristic of a component according to claim 27, wherein one of the signals is a signal modulated in accordance with the modulation scheme operated on by the component.

29. A characteristic of a component according to claim 27 or 28 wherein one of the signals is a signal modulated in accordance with the modulation scheme having a known distortion.

30. A characteristic of a component according to any one of claims 25 to 29 for performing a filtering operation associated with a characteristic in accordance with claim.

31. A characteristic of a component according to any one of claims 25 to 30 wherein a factor in the measure comprises the power of the component.

32. A characteristic of a component according to any one of claims 25 to 31 wherein the characteristic is a correlation peak to noise ratio.

33. A characteristic of a component according to any one of claims 25 to 32 wherein the component is a filter.

34. A characteristic of a component according to any claims 25 to 32 wherein the component is an amplifier.

35. A characteristic of a component according to any one of claims 25 to 32 wherein the component is a low noise amplifier.

36. A component for performing a timing operation associated with a characteristic in accordance with any one of claims 25 to 32.

37. A component according to claim 36 wherein the component for performing a timing operation comprises a clock.

38. A component according to claim 36 wherein the component for performing a timing operation comprises an automatic frequency control algorithm.

39. A component according to claim 36 wherein the component for performing a timing operation comprises a synchronization algorithm.

40. A characteristic of a component according to any one of claims 25-39 wherein the characteristic is a correlation percentage.

41. A component in accordance with any one of claims 25-40.

42. A set of components in accordance any one of claims 25-40.

43. A method for testing a signal processing component suitable for a device operating in a spread spectrum system in accordance with a predetermined modulation scheme, the method comprising:
providing an input signal;
generating an output signal modulated in accordance with the predetermined modulation scheme of known distortion from the input signal;
generating an output signal modulated in accordance with the predetermined modulation scheme and operated on by the device under test from the input signal;
correlating the modulated output signal operated on by the device under test with the modulated output signal of known distortion to provide a measure of the degradation on the signal of the component under test.

44. A method according to claim 43 wherein the step of generating an output signal of known distortion comprises modulating the input signal under the control of a clock of known distortion.

45. A method according to claim 43 or 44 wherein the step of generating an output signal operated on by the device under test comprises modulating the input signal under the control of a clock under test.

46. A method according to claim 43, 44, or 45 wherein the step of generating an output signal operated on by the device under test comprises modulating the input signal under the control of the clock and processing the signal with the component under test.

47. A method as substantially hereinbefore described with reference to FIGS. 1, 2 and 4 of the accompanying drawings.

48. A method as substantially hereinbefore described with reference to FIGS. 3 and 5 of the accompanying drawings.

49. A characteristic of a component as substantially hereinbefore described with reference to FIGS. 1, 2 and 4 of the accompanying drawings.

50. A characteristic of a component as substantially hereinbefore described with reference to FIGS. 3 and 5 of the accompanying drawings.

51. A component as substantially hereinbefore described with reference to FIGS. 1, 2 and 4 of the accompanying drawings.

52. A component as substantially hereinbefore described with reference to FIGS. 3 and 5 of the accompanying drawings.

53. A set of components as substantially hereinbefore described with reference to FIGS. 1, 2 and 4 of the accompanying drawings.

54. A set of components as substantially hereinbefore described with reference to FIGS. 3 and 5 of the accompanying drawings.

55. A data sheet for association with a component or set of similar components providing a correlation peak measure for a specified spread spectrum modulation scheme indicating the signal distortion attributable to the component operating on a signal modulated in accordance with the specified scheme.

56. A data sheet for association with a component or set of similar components as substantially hereinbefore described with reference to FIGS. 1, 2 and 4 of the accompanying drawings.

57. A data sheet for association with a component or set of similar components as substantially hereinbefore described with reference to FIGS. 3 and 5 of the accompanying drawings.
